(19) United States
(12) Patent Application Publication
(10) Pub. No.: US 2025/0103381 A1
(43) Pub. Date: Mar. 27, 2025

(54) SCHEDULING EXECUTION OF COMMANDS IN A DATA STORAGE DEVICE BASED ON COMMAND PARAMETERS

(71) Applicant: Western Digital Technologies, Inc., San Jose, CA (US)

(72) Inventors: Bharath Radhakrishnan, Pulau Pinang (MY); Uthayarajan A/L Rasalingam, Penang (MY); Patrick Go, Ipoh (MY); Ramanathan Muthiah, Bangalore (IN); Judah Gamliel Hahn, Ofra (IL)

(21) Appl. No.: 18/473,774

(22) Filed: Sep. 25, 2023

(51) Int. Cl. G06F 9/48

(52) U.S. Cl. CPC G06F 9/48

(57) ABSTRACT

A scheduling system of a computing device analyzes a received command to identify one or more command parameters associated with the command. The command parameters include data attributes associated with the command, data location information associated with the command and command attributes associated with the command. The scheduling system also determines an execution weight of each command parameter associated with the command. A force for the command is also determined. The force is proportional to the execution weight of each command parameter that is associated with the command. The scheduling system orders the command in a command queue based, at least in part, on the determined force.

### BACKGROUND

A data storage device receives and executes a number of different commands. Typically, when a command is received, a scheduler associated with a controller and/or firmware of the data storage device determines an execution order for the received commands.

For example, when commands are received, the scheduler may cause the commands to be placed in a command queue and executed in a first-come, first-serve basis. In another example, the scheduler places received commands in different command queues. The commands in each command queue are then executed in a round-robin manner. In yet other examples, one command queue may have a higher priority when compared with a priority of another command queue. As such, commands in the higher priority command queue are typically executed before commands in the lower priority command queue. However, none of these scheduling methods are the most efficient or effective in terms of latency, throughput and/or performance.

Accordingly, it would be beneficial to improve scheduling techniques utilized by a scheduler of a data storage device to improve the overall performance of the data storage device.

### SUMMARY

The present application describes determining an execution order for various commands received by a computing device. In an example, the computing device is a data storage device and the commands are received by a controller and/or firmware associated with the data storage device. The execution order of the various commands is based on a determined “force” associated with each command.

For example, when a command is received, a scheduling system associated with the data storage device determines or identifies one or more command parameters associated with the command. In an example, the command parameters include one or more data attributes associated with the received command. In another example, the command parameters include data location information associated with the received command. In yet another example, the command parameters include command attributes associated with the received command.

The scheduling system also determines an execution weight associated with each of the command parameters. The force is then determined using the execution weight of each of the one or more command parameters. For example, the force of the command is proportional to the execution weight of each of the one or more command parameters. When the force of the command is determined, the force of the command is compared against a determined force associated with the various other commands. The commands are then executed in a sequence or order specified by the force (e.g., the commands with the highest force are executed first).

Accordingly, examples of the present disclosure describe a method that includes receiving a command for execution on a data storage device. When the command is received, command parameters associated with the command are determined. In an example, the command parameters are selected from a group of command parameters including a data attribute parameter, a data location parameter and a command attribute parameter. An execution weight for one or more of the command parameters is determined. An execution order for the command is then determined and is based, at least in part, on the execution weight of the one or more command parameters.

The present disclosure also describes a system that includes a controller and a memory for storing instructions. When the controller executes the instructions, various operations are performed. In an example, the operations include determining one or more command parameters associated with a received command. In an example, the one or more command parameters are selected from a group of command parameters. The command parameters include a data attribute parameter, a data location parameter and a command attribute parameter. The operations also include determining an execution weight for each of the one or more command parameters. A force associated with the command is then determined. In an example, the force is proportional to the execution weight of each of the one or more command parameters.

A system is also described. In an example, the system includes means for receiving a command associated with a data storage device and means for determining one or more command parameters associated with the command. In an example, the one or more command parameters are selected from a group of command parameters including a data attribute parameter, a data location parameter and a command attribute parameter. The system also includes means for determining an execution weight for the command. In an example, the execution weight is based, at least in part, on the one or more command parameters. The system also includes means for determining an execution order for the command based, at least in part, on the execution weight of the one or more command parameters

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2 illustrates a data storage device having an associated scheduling system according to an example.

FIG. 3A illustrates a command queue in which a number of commands have been ordered based, at least in part, on a determined force according to an example.

FIG. 3B illustrates the command queue of FIG. 3A when a new command is received according to an example.

FIG. 4 illustrates a method for determining a force of a received command according to an example.

FIG. 5 is a perspective view of a storage device that includes three-dimensional (3D) stacked non-volatile memory according to an example.

FIG. 6 is a block diagram of a storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

A data storage device, such as a solid-state drive (SSD), receives and executes a number of commands. When a command is received, a scheduler associated with a controller and/or firmware of the data storage device manages the received commands and optimizes execution of the commands.

In one example, when commands are received, the scheduler causes the commands to be executed in a first-come, first-serve basis. In other examples, when commands are received, the scheduler places the commands in different queues. The commands in each of the queues may then be executed in a round-robin manner or based on weighted characteristics associated with each queue (e.g., one queue may be prioritized higher than another queue).

However, current methods of scheduling and executing commands may be further optimized. Accordingly, examples of the present disclosure describe determining an execution order for various commands based on a determined force associated with each command. In an example, the force is based, at least in part, on various command parameters associated with the command. For example, when a command is received, a scheduling system associated with the data storage device analyzes the command and determines one or more data attributes associated with the received command, data location information associated with the received command and/or command attributes associated with the received command.

When the command attributes are determined, an execution weight associated with each of the command parameters is determined. The force associated with the command is then determined using the execution weight. For example, the force of the command is proportional to the execution weight of each of the one or more command parameters. When the force of the command is determined, the force of the command is compared against a determined force associated with various other commands that have been received. The commands are then executed in a sequence or order specified by the force.

Accordingly, many technical benefits may be realized including, but not limited to, improved command sequencing when compared with current solutions, improved performance of the data storage device while decreasing latency and increasing throughput, and increasing the life of the data storage device.

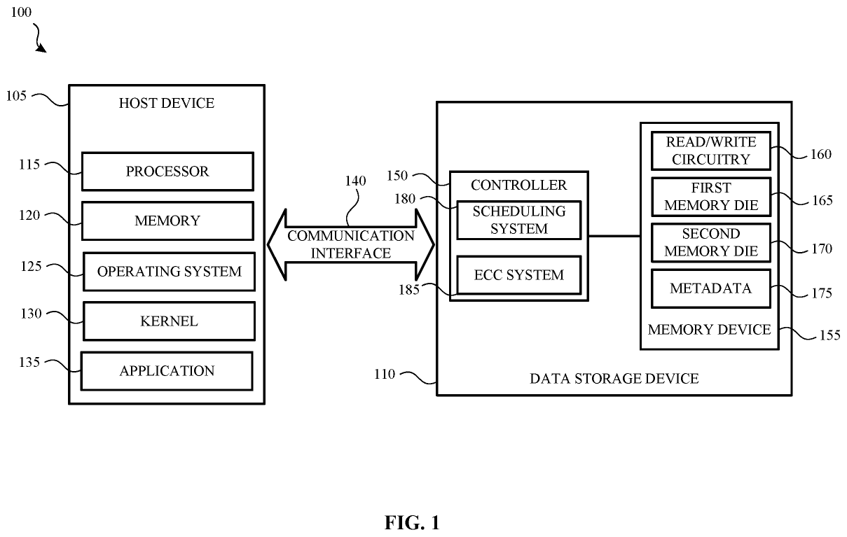

These benefits, along with other examples, will be shown and described in greater detail with respect to FIG. 1-FIG. 6.

FIG. 1 is a block diagram of a system 100 that includes a host device 105 and a data storage device 110 according to an example. The host device 105 includes a processor 115 and a memory 120 (e.g., a main memory). The memory 120 may include or otherwise be associated with an operating system 125, a kernel 130 and/or an application 135.

The processor 115 can execute various instructions, such as, for example, instructions from the operating system 125 and/or the application 135. The processor 115 may include circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 includes a System on a Chip (SoC).

In an example, the memory 120 is used by the host device 105 to store data used, or otherwise executed by, the processor 115. Data stored in the memory 120 includes instructions provided by the data storage device 110 via a communication interface 140. The data stored in the memory 120 also includes data used to execute instructions from the operating system 125 and/or one or more applications 135. The memory 120 may be a single memory or may include multiple memories, such as, for example one or more non-volatile memories, one or more volatile memories, or a combination thereof.

In an example, the operating system 125 creates a virtual address space for the application 135 and/or other processes executed by the processor 115. The virtual address space may map to locations in the memory 120. The operating system 125 may also include or otherwise be associated with a kernel 130. The kernel 130 includes instructions for managing various resources of the host device 105 (e.g., memory allocation), handling read and write operations and so on.

The communication interface 140 communicatively couples the host device 105 and the data storage device 110. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as Non-Volatile Memory express (NVMe) or Advanced Host Controller Interface (AHCI).

In an example, the data storage device 110 includes a controller 150 and a memory device 155. The controller 150 may be communicatively coupled to the memory device 155. In an example, the memory device 155 includes one or more memory dies (e.g., a first memory die 165 and a second memory die 170). Although memory dies are specifically mentioned, the memory device 155 may include any non-volatile memory device, storage device, storage elements or storage medium including NAND flash memory cells and/or NOR flash memory cells.

The memory cells can take the form of solid-state (e.g., flash) memory cells and can be one-time programmable, few-time programmable, or many-time programmable. Additionally, the memory cells may be single-level cells (SLCs), multi-level cells (MLCs), triple-level cells (TLCs), quad-level cells (QLCs), penta-level cells (PLCs), and/or use any other memory technologies. The memory cells may be arranged in a two-dimensional configuration or a three-dimensional configuration.

In an example, the data storage device 110 is attached to or embedded within the host device 105. In another example, the data storage device 110 is an external device or a portable device that is communicatively or selectively coupled to the host device 105. In yet another example, the data storage device 110 is a component (e.g., a solid-state drive (SSD)) of a network accessible data storage system, a network-attached storage system, a cloud data storage system, and the like.

As previously explained, the memory device 155 of the data storage device 110 includes a first memory die 165 and a second memory die 170. Although two memory dies are shown, the memory device 155 may include any number of memory dies (e.g., one memory die, two memory dies, eight memory dies, or another number of memory dies).

The memory device 155 also includes support circuitry. In an example, the support circuitry includes read/write circuitry 160. The read/write circuitry 160 supports the operation of the memory dies of the memory device 155. Although the read/write circuitry 160 is depicted as a single component, the read/write circuitry 160 may be divided into separate components, such as, for example, read circuitry and write circuitry. The read/write circuitry 160 may be external to the memory dies of the memory device 155. In another example, one or more of the memory dies may include corresponding read/write circuitry 160 that is operable to read data from and/or write data to storage elements within one individual memory die independent of other read and/or write operations on any of the other memory dies.

Each of the first memory die 165 and the second memory die 170 may include one or more memory blocks. In an example, each memory block includes one or more memory cells. A block of memory cells is the smallest number of memory cells that are physically erasable together. In an example and for increased parallelism, each of the blocks may be operated or organized in larger blocks or metablocks. For example, one block from different planes of memory cells may be logically linked together to form a metablock.

The memory blocks are referred to herein as physical memory blocks because they relate to groups of physical memory cells. As used herein, a logical memory block is a virtual unit of address space defined to have the same size as a physical memory block. Each logical memory block includes a range of logical memory block addresses (LBAs) that are associated with data received from a host. The LBAs are then mapped to one or more physical memory blocks in the data storage device 110 where the data is physically stored.

As previously described, the data storage device 110 also includes a controller 150. The controller 150 is communicatively coupled to the memory device 155 via a bus, an interface or other communication circuitry. In an example, the communication circuitry includes one or more channels to enable the controller 150 to communicate with the first memory die 165 and/or the second memory die 170 of the memory device 155. In another example, the communication circuitry includes multiple distinct channels which enables the controller 150 to communicate with the first memory die 165 independently and/or in parallel with the second memory die 170 of the memory device 155.

The controller 150 also receives data and/or instructions/commands from the host device 105. The controller 150 may also cause data to be sent to the host device 105. For example, the controller 150 may send data to and/or receive data from the host device 105 via the communication interface 140. The controller 150 also sends data and/or commands to and/or receives data from, the memory device 155.

When the controller 150 receives data and/or commands, the controller 150 causes the commands to be executed on one or more of the memory dies in the memory device 155. For example, if the command is a write command, the controller 150 causes the memory device 155 to store data associated with the command at a specified physical address or memory block of the memory device 155. If the command is a read command, the controller 150 causes data to be read from the specified physical address of the memory device 155. The controller 150 may also execute various system commands and/or other background operations. These commands and/or operations include background scanning operations, garbage collection operations, and/or wear leveling operations.

In an example, the controller 150 includes, or is otherwise associated with, a scheduling system 180. The scheduling system is responsible for determining a sequence or an order in which received commands are executed. The scheduling system 180 also helps ensure the commands are executed in the determined sequence. Additionally, the scheduling system 180 may also dynamically alter the sequence of the commands when new commands are received.

As previously discussed, the controller 150 may receive various commands. In an example, the commands are received from the host device 105. The commands that are received from the host device 105 may be read, write and/or erase commands. The controller may also receive system commands such as previously described.

When a command is received, the scheduling system 180 analyzes the command to determine command parameters associated with the command. Once the command parameters are determined, the scheduling system determines an execution weight for each of the command parameters. When the execution weight for each command parameter is determined, a force for the command is determined.

In an example, the force is proportional to the execution weight of each command parameter. For example, the Force (F) associated with the command may be determined by the following equation:

$$F α {\sum }_{i = 0}^{n} ( weight ( i ) * parameter ( i ) )$$

in which n is the total number of command parameters associated with the command.

In an example, the command parameters fall into three (or more) categories. Further, each of the categories may be arranged in a hierarchy or otherwise be associated with a priority/precedence. Thus, if the determined force of two (or more commands) is the same, the command having a higher weight in one of the categories (e.g., a data attribute category) may be ordered before the other command.

In an example, the first category is a data attribute category. The data attribute category may receive the most weight, or have the most precedence, when compared with the other two categories. The data attribute category includes information about the data associated with the received command.

For example, the data attribute category includes a size of data associated with the command. In an example, as the size of the data associated with the command decreases, the weight associated with the command increases. For example, a four kilobyte (KB) command may have a higher weight when compared to a one-megabyte (MB) command.

In an example, the scheduling system 180 sets a standard command size (e.g., 64 KB) as a benchmark across a command queue. In this example, the command queue has a queue depth (QD) of 32. The proportion is represented as the standard command size multiplied by the queue depth. Thus, the proportion is 64 KB*32 QD=2048 KB. 2048 KB is equivalent to 512 units of 4 KB fragments. Additionally, each 64 KB command is 16 units of 4 KB. Using the above, we can determine an execution weight of a command based on the size of data associated with the command.

For example, if the size of the command (or a size of data associated with the command) is 64 KB, the weight of the command is 32 (e.g., 512/16=32). However, if the size of the command is 4 KB, the weight of the command is 512 (e.g., 512/1=512). In another example, if the size of the command is 512 KB, the weight of the command is 4 (e.g., 512/128=4). Although specific examples are given, other benchmarks may be used to determine an execution weight based on the size of the received command.

Although smaller commands may be ordered before larger commands, the scheduling system 180 will consider command overlap cases and schedule execution of the commands accordingly. For example, if a read command associated with a particular logical block address (LBA) is received, followed by a write command on that LBA, followed by another read command on that same LBA, the scheduling system 180 will ensure that the proper command sequence with respect to the LBA is followed.

For example, the scheduling system 180 may cause the initial read command to be executed first, followed by the write command, and subsequently followed by the second read command. This order may be maintained regardless of whether the size of one command (e.g., the write command) is larger than one of the other commands (e.g., the second read command).

The weight associated with the data attribute category may also include historical information about data associated with a command and/or a region in the memory device 155 associated with the command. In an example, the historical information includes “temperature” information (or a “hotness”) associated with the command and/or a temperature (or a hotness) of a region associated with the command. In an example, the temperature (or hotness) associated with the command and/or the region is based, at least in part, on how frequently the data associated with the command/region is accessed.

For example, when a hot region is accessed (especially for a read command), the scheduling system 180 may give a higher weight to the commands associated with the hot region when compared with commands that are associated with “cold” regions. In another example, the scheduling system 180 gives higher weights to specific regions which are usually associated with specific applications 135 being executed by the host device 105. For example, regions associated with applications 135 that are executed more frequently when compared with other applications 135 may be given higher weights.

The second category is a data location category. In an example, the data location category includes a physical (or logical) location of data associated with the received command. For example, if the command is a read command, the data location associated with the command is a physical location of a memory block (or blocks) from which the data is to be written and/or read. In addition to the physical location, the scheduling system 180 may determine an age of the memory block that will be accessed by the command and/or an error rate associated with the memory block. In an example, the physical location, the age and/or the bit error rate (BER) may each be associated with its own execution weight. For example, a memory block or data with a low BER may have a higher weight when compared to a memory block and/or data with a high BER. Likewise, a memory block having newer data (e.g., an age of the data) may have a higher weight when compared with a memory block having older data.

To determine the BER, the scheduling system 180 may communicate with an error code correction (ECC) system 185. The ECC system 185 determines the BER of data associated with the particular command and/or memory block. In another example, the ECC system 185 determines or otherwise tracks a failed bit count, a syndrome weight, and/or other metrics associated with a particular memory block (or memory blocks).

When the scheduling system 180 determines the memory access (physical address) associated with a command will need error recovery procedures (based on underlying BER data for the accessed memory block), the scheduling system 180 can modify the weight such that other commands (e.g., the commands that are smaller size) are executed prior to the commands with the higher BER. As such, the scheduling system 180 can group all commands with higher BER association to one state machine, delay them until the specification allows and break the pipeline as minimal number of times as possible.

In yet another example, groupwise completion of commands associated with a logical region may also minimize overhead, since the amount of swap-in and swap-out of the logical to physical pages from a logical to physical cache may be reduced. Accordingly, the scheduling system 180 may dynamically increase the weight of command when the scheduling system 180 determines that command under consideration is part of a logical group that is already in progress.

The third category is a command attribute category. In an example, the command attribute category includes information associated with the command. For example, the command attribute category includes command type information that indicates whether the command is a program, read or erase command. The command attribute category may also include information regarding the origin of the command. For example, the command origin information may indicate whether the command was received from the host device 105 or whether the command is a system command or otherwise originated internally. In yet another example, the command attribute category includes a command time that indicates how long the command has been in the command queue.

As with the other categories, the command type information, the origin information and the command time information may each be associated with a determined execution weight. For example, a read command may be given a higher execution weight when compared with a write command and/or an erase command. In another example, a command from the host device 105 may have a higher execution weight when compared to a system command.

However, a system command may have a higher execution weight when compared to the command from the host device 105 depending on a state of the memory device 155. For example, if the memory device is reaching capacity or has under a threshold number of available memory blocks, the scheduling system 180 may cause one or more system commands (e.g., garbage collection commands) to be executed (e.g., have a higher execution weight) before the commands from the host device 105.

In yet another example, the longer the command has been in the command queue, the higher the execution weight. For example, an execution weight associated with a command may dynamically increase the longer the command is in the command queue.

As previously indicated, when the command is received, the scheduling system 180 analyzes the command to determine command parameters and an execution weight for each of the command parameters. When the execution weight for each command parameter is determined, the scheduling system determines the force for the received command. The scheduling system 180 may then order the commands based, at least in part, on the determined force.

In an example, the scheduling system 180 dynamically updates and/or determines the force of a command each time a command is received. In another example, the scheduling system 180 may also periodically update or revise the force of other, previously received commands. The dynamic update of the force of the previously received commands may occur after a threshold number of commands have been received, after a threshold number of commands have been executed, and/or after a threshold amount of time has passed. Although specific examples have been given, the force may be determined and/or dynamically updated based on any number of factors.

The scheduling system 180 may also determine a force based on a first time parameter and a second time parameter. In an example, the first time parameter and the second time parameter may be different than the amount of time a command has been in the command queue. For example, when a command is received, the scheduling system 180 may determine that the earliest possible time to schedule a command is the time the command reaches the scheduling system 180. This is referred to as the “as soon as possible time” (Tasap). The scheduling system may also determine the furthest time a command can be delayed. This is referred to as the “as late as possible time” (Talap).

Using the first time parameter and the second time parameter, the scheduling system may determine that every received command should be scheduled between Tasap and Talap. Thus, Tasap<=Tsched<=Talap. Therefore, in some examples, once Talap has been reached for a command, the scheduling system 180 may cause the command to be executed regardless of the determined force.

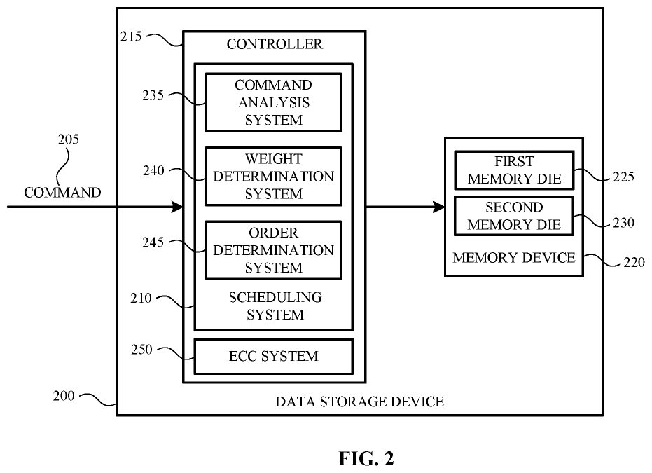

FIG. 2 illustrates a data storage device 200 having an associated scheduling system 210 according to an example. In an example, the data storage device 200 may be similar to the data storage device 110 shown and described with respect to FIG. 1. Likewise, the scheduling system 210 may be similar to the scheduling system 180 shown and described with respect to FIG. 1.

In an example, the data storage device 200 includes or is otherwise associated with a controller 215. The controller 215 may also be associated with the scheduling system 210. The data storage device 200 may also include or otherwise be associated with a memory device 220. The memory device 220 may have a first memory die 225 and a second memory die 230.

In an example, the data storage device 200 receives a command 205. The command 205 may be received from a host device (e.g., host device 105 (FIG. 1)) or the command 205 may be a system/internal command. Additionally, the command 205 may be executed on the first memory die 225 and/or the second memory die 230 of the memory device 220.

When the command 205 is received, the controller 215 (or firmware associated with the data storage device 200 and/or the controller 215) provides the command 205 to the scheduling system 210. A command analysis system 235 of the scheduling system 210 analyzes the command 205 to determine one or more command parameters associated with command 205. As previously explained, the command parameters include one or more of: data attribute parameters including a data size parameter and a temperature parameter; a data location parameter including a LBA range parameter, a physical memory block location parameter and a code rate parameter (e.g., determined by an ECC system 250); and a command attribute parameter including a command type parameter, a command origin parameter and a command time parameter.

When the command parameters are determined, a weight determination system 240 calculates an execution weight for each of the identified/determined parameters associated with the command 205. For example, the weight determination system 240 may determine a weight for one or more of the data size parameter, the temperature parameter, the LBA range parameter, the physical memory block location parameter, the code rate parameter, the command type parameter, the command origin parameter and/or the command time parameter.

An order determination system 245 may then use the determined execution weight for each of the one or more parameters to determine a force for the command. As previously discussed, the force is proportional to the execution weight of each command parameter and may be determined using the following equation:

$$F α {\sum }_{i = 0}^{n} ( weight ( i ) * parameter ( i ) )$$

When the force is determined, the order determination system 245 compares the force of the command 205 to a force of one or more previously received commands. The command 205 may then be placed in a command queue for execution.

In an example, the scheduling system 210 is a free flow system. As such, the scheduling system 210 includes one or more soft mechanisms to handle various deviations. For example, when the controller 215 determines that certain command queues have commands that have aged beyond a determined threshold a time limit (e.g., as determined by a system design or as hinted by a host device), the aged commands may be forcefully executed by the scheduling system 210 before the time elapses.

In examples in which the data storage device 200 is shared (e.g., in a multi-host system), the scheduling system 210 may ensure that one host does not arbitrarily take away bandwidth of the data storage device 200 at the cost of the other hosts. Likewise, in a multi-stream workload, the scheduling system 210 may manage the various streams to ensure that the streams are balanced and ordered and that a sufficient amount of bandwidth is provided to each stream.

In yet another example, the scheduling system 210 may be used across various different controllers. For example, the scheduling system 210 may include or otherwise be associated with a resource utilization index (RUI) for a command associated with a stream of a host device. Because a larger command would consume more backend resources, RUI may be increased for larger commands and decreased proportionately for smaller commands. As such, the scheduling system 210 can learn and adapt to a multi-stream environment with slow-drip sensors that need to be written immediately. In such an example, the execution weight would be an inverse of the RUI which would prioritize commands that take the least amount bandwidth. For example, an ordering of commands may be based on stream write size or stream granularity size.

In yet another example, the scheduling system 210 may modify its rules based, at least in part, on an application being executed and/or on preferences of a host device. For example, an RUI of 16 KB would carry the least weight or preference while the force would carry the highest preference. As such, the data storage device would prioritize the commands with the highest force when compared with the RUI. In an example, the host device may mostly provide 16 KB commands. As such, those commands may have the maximum force.

In addition, in a multi-host environment, each host may have different arbitration burst lengths per controller and different response latencies over a communication channel (e.g., a PCIe communication channel). As such, the controller 215 may have a fixed bandwidth per host device (e.g., uniformly distribute available RUI across the host devices). The bandwidth may also be shared and/or divided across the various streams of the host devices. As such, one host device cannot disturb another host device. Likewise, if a host device has a specific requirement, that requirement may be tweaked within the available RUI where some data sizes may be the preference.

For example, if the total device RUI=TOTAL, the RUI may be shared across different host devices as: Host 1 RUI+Host 2 RUI . . . Host N RUI=TOTAL. A RUI of 4K command=1; an RUI of 8K command=2 and so on. Within a particular host device (e.g., Host 1), multiple streams may share the RUI of that particular host device.

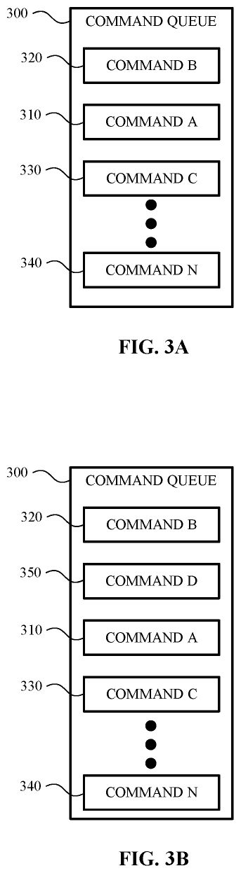

FIG. 3A illustrates a command queue 300 in which a number of commands have been ordered based, at least in part, on a determined force according to an example. In an example, the command queue 300 may be associated with a data storage device such as, for example, the data storage device 110 shown and described with respect to FIG. 1. Additionally, although a single command queue 300 is shown, the data storage device may include multiple different command queues.

In the example shown, the command queue 300 already includes N commands: Command A 310, Command B 320, Command C 330 and Command N 340. In this example, each of the commands were received in alphabetical order (e.g., Command A 310 was received before Command B 320). However, when each command was received, a scheduling system (e.g., the scheduling system 180 (FIG. 1)) determined a force for each of the commands and ordered the commands in the command queue 300 based, at least in part, on the determined force.

For example, due to the determined force of Command B 320 with respect to Command A 310 and Command C 330, Command B 320 will be executed first. Once Command B 320 has been executed, Command A 310 will be executed followed by Command C 330.

FIG. 3B illustrates the command queue 300 of FIG. 3A when a new command is received according to an example. In this example, the new command is Command D 350. When Command D 350 is received by the scheduling system, the force associated with Command D 350 is determined.

Once the force for Command D 350 is determined, the scheduling system uses the force to sequence the execution order for the various memory dies of the memory device. For example, if the force for Command D 350 is higher than the force for the rest of the commands in the command queue 300, Command D 350 will be positioned at the head of the command queue 300 for immediate (or upcoming) execution. Likewise, based on the comparison, Command D 350 can be positioned somewhere in the middle or at the tail of the command queue 300. Additionally, the scheduling system may position multiple commands in multiple different command queues that service multiple memory dies and each command will be executed in an order according to its determined force.

In this example, the force associated with Command D 350 is greater than Command A 310 but less than Command B 320. As such, Command D 350 is placed in the command queue 300 between Command A 310 and Command B 320.

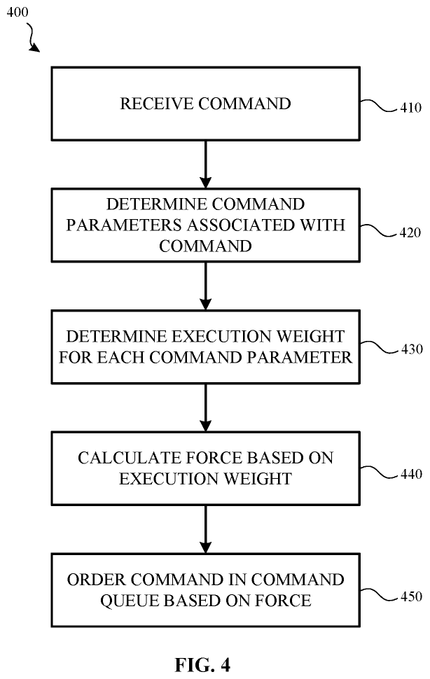

FIG. 4 illustrates a method 400 for determining a force of a received command according to an example. In an example, the method 400 is performed by a scheduling system of a data storage device. The scheduling system may be similar to the scheduling system 180 shown and described with respect to FIG. 1. In an example, the method 400 may be performed each time a command is received by the data storage device. In another example, the method 400 is performed after a threshold number of commands have been received and/or after a threshold number of commands are in one or more command queues waiting to be executed. Thus, the method 400 may be executed based, at least in part, on an operating state of the data storage device.

Method 400 begins when a command is received (410). As previously indicated, the command may be received by a controller of the data storage device and/or the scheduling system of the data storage device. The command may be received from a host device or the command may be a system command.

When the command is received, a scheduling system determines (420) one or more command parameters associated with the command. In an example, the command parameters may be hierarchically arranged such that one or more command parameters are weighted heavier when compared with other command parameters. The command parameters include, but are not limited to, data attribute parameters including a data size parameter and a temperature parameter; a data location parameter including a LBA range parameter, a physical memory block location parameter and a code rate parameter; and a command attribute parameter including a command type parameter, a command origin parameter and a command time parameter.

The scheduling system also determines (430) an execution weight for each command parameter that was identified in the previous operation. For example, a data size parameter of a command may be 512, a temperature parameter may be 10 (indicating the data is “hot”), and a command origin parameter may be 2 (indicating the command is from a host device). Although execution weights of three command parameters is described, execution weights for every command parameter may be determined.

When the execution weight for each command parameter is determined, the scheduling system calculate (440) a force based, at least in part, on the execution weight. Continuing with the example above, the execution weight for the received command would be 524 (e.g., 512+10+2=524).

The scheduling system will then order (450) the command based, at least in part, on the determined force. For example, the scheduling system will compare the force of the command (e.g., 524) to the force of other commands in one or more command queues. The command will be placed in the command queue before previously received commands with a force lower than 524 but after commands with a force higher than 524.

In examples in which another command has the same force (e.g., both commands have a force of 524), the command having a higher weight in a command parameter with a higher position in the hierarchy (e.g., a data attribute parameter) will be executed first.

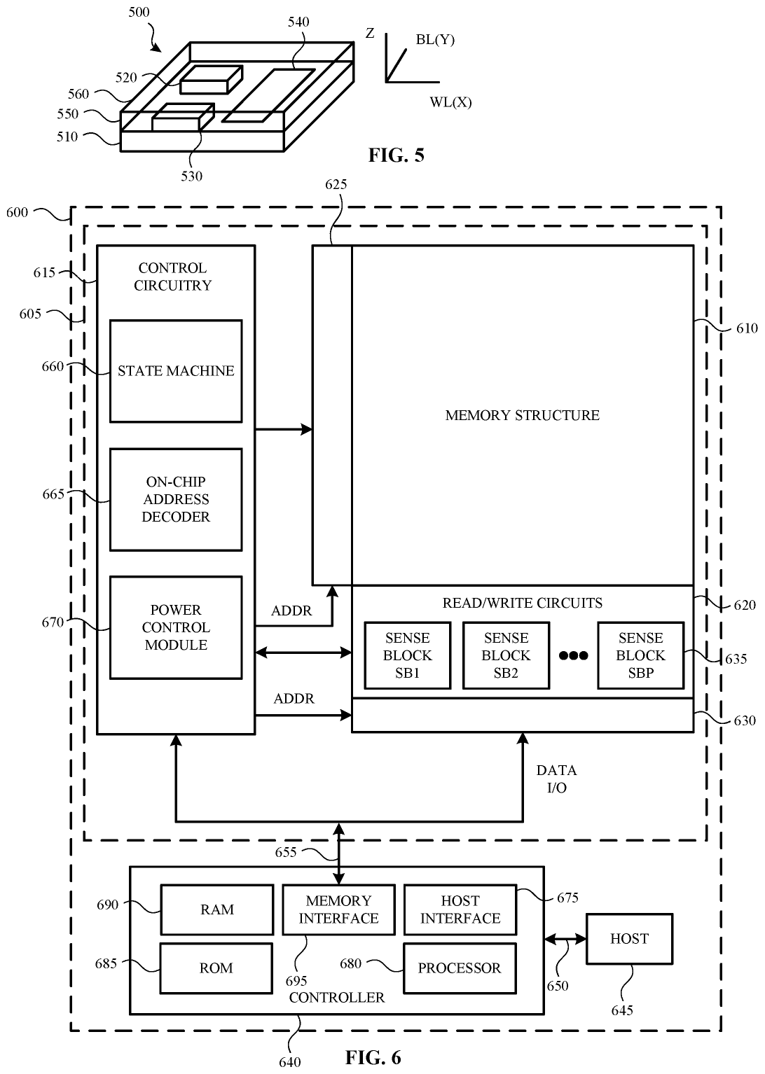

FIG. 5-FIG. 6 describe example storage devices that may be used with or otherwise implement the various features described herein. For example, the storage devices shown and described with respect to FIG. 5-FIG. 6 may include various systems and components that are similar to the systems and components shown and described with respect to FIG. 1. For example, the controller 622 shown and described with respect to FIG. 6 may be similar to the controller 150 of FIG. 1. Likewise, the memory dies 608 may be similar to the first memory die 165 and/or the second memory die 170 of FIG. 1.

FIG. 5 is a perspective view of a storage device 500 that includes three-dimensional (3D) stacked non-volatile memory according to an example. In this example, the storage device 500 includes a substrate 510. Blocks of memory cells are included on or above the substrate 510. The blocks may include a first block 520 (BLK0) and a second block 530 (BLK1). Each block may be formed of memory cells (e.g., non-volatile memory elements). The substrate 510 may also include a peripheral area 540 having support circuits that are used by the first block 520 and the second block 530. The peripheral area 540 may be located beneath the first block 520 and the second block 530. In another example, the peripheral area may be included on a different substrate or die.

The substrate 510 may also carry circuits under the blocks, along with one or more lower metal layers which are patterned in conductive paths to carry signals from the circuits. The blocks may be formed in an intermediate region 550 of the storage device 500. The storage device may also include an upper region 560. The upper region 560 may include one or more upper metal layers that are patterned in conductive paths to carry signals from the circuits. Each block of memory cells may include a stacked area of memory cells. In an example, alternating levels of the stack represent wordlines. While two blocks are depicted, additional blocks may be used and extend in the x-direction and/or the y-direction.

In an example, a length of a plane of the substrate 510 in the x-direction represents a direction in which signal paths for wordlines or control gate lines extend (e.g., a wordline or drain-end select gate (SGD) line direction) and the width of the plane of the substrate 510 in the y-direction represents a direction in which signal paths for bit lines extend (e.g., a bit line direction). The z-direction represents a height of the storage device 500.

FIG. 6 is a functional block diagram of a storage device 600 according to an example. In an example, the storage device 600 may be the 3D stacked non-volatile storage device 500 shown and described with respect to FIG. 5. The components depicted in FIG. 6 may be electrical circuits. In an example, the storage device 600 includes one or more memory dies 605. Each memory die 605 includes a three-dimensional memory structure 610 of memory cells (e.g., a 3D array of memory cells), control circuitry 615, and read/write circuits 620. In another example, a two-dimensional array of memory cells may be used. The memory structure 610 is addressable by wordlines using a first decoder 625 (e.g., a row decoder) and by bit lines using a second decoder 630 (e.g., a column decoder). The read/write circuits 620 may also include multiple sense blocks 635 including SB1, SB2, . . . , SBp (e.g., sensing circuitry) which allow pages of the memory cells to be read or programmed in parallel. The sense blocks 635 may include bit line drivers.

In an example, a controller 640 is included in the same storage device 600 as the one or more memory dies 605. In another example, the controller 640 is formed on a die that is bonded to a memory die 605, in which case each memory die 605 may have its own controller 640. In yet another example, a controller die controls all of the memory dies 605.

Commands and data may be transferred between a host 645 and the controller 640 using a data bus 650. Commands and data may also be transferred between the controller 640 and one or more of the memory dies 605 by way of lines 655. In one example, the memory die 605 includes a set of input and/or output (I/O) pins that connect to lines 655.

The memory structure 610 may also include one or more arrays of memory cells. The memory cells may be arranged in a three-dimensional array or a two-dimensional array. The memory structure 610 may include any type of non-volatile memory that is formed on one or more physical levels of arrays of memory cells having an active area disposed above a silicon substrate. The memory structure 610 may be in a non-volatile memory device having circuitry associated with the operation of the memory cells, whether the associated circuitry is above or within the substrate.

The control circuitry 615 works in conjunction with the read/write circuits 620 to perform memory operations (e.g., erase, program, read, and others) on the memory structure 610. The control circuitry 615 may include registers, ROM fuses, and other devices for storing default values such as base voltages and other parameters.

The control circuitry 615 may also include a state machine 660, an on-chip address decoder 665, and a power control module 670. The state machine 660 may provide chip-level control of various memory operations. The state machine 660 may be programmable by software. In another example, the state machine 660 does not use software and is completely implemented in hardware (e.g., electrical circuits).

The on-chip address decoder 665 may provide an address interface between addresses used by host 645 and/or the controller 640 to a hardware address used by the first decoder 625 and the second decoder 630.

The power control module 670 may control power and voltages that are supplied to the wordlines and bit lines during memory operations. The power control module 670 may include drivers for wordline layers in a 3D configuration, select transistors (e.g., SGS and SGD transistors) and source lines. The power control module 670 may include one or more charge pumps for creating voltages.

The control circuitry 615, the state machine 660, the on-chip address decoder 665, the first decoder 625, the second decoder 630, the power control module 670, the sense blocks 635, the read/write circuits 620, and/or the controller 640 may be considered one or more control circuits and/or a managing circuit that perform some or all of the operations described herein.

In an example, the controller 640, is an electrical circuit that may be on-chip or off-chip. Additionally, the controller 640 may include one or more processors 680, ROM 685, RAM 690, memory interface 695, and host interface 675, all of which may be interconnected. In an example, the one or more processors 680 is one example of a control circuit. Other examples can use state machines or other custom circuits designed to perform one or more functions. Devices such as ROM 685 and RAM 690 may include code such as a set of instructions. One or more of the processors 680 may be operable to execute the set of instructions to provide some or all of the functionality described herein.

Alternatively or additionally, one or more of the processors 680 may access code from a memory device in the memory structure 610, such as a reserved area of memory cells connected to one or more wordlines. The memory interface 695, in communication with ROM 685, RAM 690, and one or more of the processors 680, may be an electrical circuit that provides an electrical interface between the controller 640 and the memory die 605. For example, the memory interface 695 may change the format or timing of signals, provide a buffer, isolate from surges, latch I/O, and so forth.

The one or more processors 680 may issue commands to control circuitry 615, or any other component of memory die 605, using the memory interface 695. The host interface 675, in communication with the ROM 685, the RAM 695, and the one or more processors 680, may be an electrical circuit that provides an electrical interface between the controller 640 and the host 645. For example, the host interface 675 may change the format or timing of signals, provide a buffer, isolate from surges, latch I/O, and so on. Commands and data from the host 645 are received by the controller 640 by way of the host interface 675. Data sent to the host 645 may be transmitted using the data bus 650.

Multiple memory elements in the memory structure 610 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a RAM configuration.

Examples of the present disclosure describe receiving a command for execution on a data storage device; determining command parameters associated with the command, the command parameters being selected from a group of command parameters including a data attribute parameter, a data location parameter and a command attribute parameter; determining an execution weight for one or more of the command parameters; and determining an execution order for the command based, at least in part, on the execution weight of the one or more command parameters. In an example, the execution order is based, at least in part, on a determined force and wherein the determined force is proportional to the execution weight of the one or more command parameters. In an example, the command is a system command. In an example, the command is received from a host device. In an example, the execution order is based, at least in part, on a first time parameter and a second time parameter. In an example, the data attribute command parameter includes one or more of a size of data associated with the command and a temperature of the data associated with the command. In an example, the data location command parameter includes one or more of a logical block address (LBA) associated with the command, a physical location of a memory block associated with the command, an age of the memory block associated with the command and a code rate associated with the memory block. In an example, the command attribute command parameter includes one or more of a command type, a command origin and a time parameter. In an example, the execution weight is determined based, at least in part, on a number of received commands exceeding a threshold.

Examples also describe a system, comprising: a controller; and a memory storing instructions that, when executed by the controller, perform operations, comprising: determining one or more command parameters associated with a received command, the one or more command parameters being selected from a group of command parameters including, a data attribute parameter, a data location parameter and a command attribute parameter; determining an execution weight for each of the one or more command parameters; and determining a force associated with the command, wherein the force is proportional to the execution weight of each of the one or more command parameters. In an example, the instructions also include instructions for determining an execution order for the command based, at least in part, on the force. In an example, the instructions also include instructions for comparing the force of the command to a force of one or more previously received commands. In an example, the data attribute command parameter includes one or more of a size of data associated with the command and a temperature of the data associated with the command. In an example, the data location command parameter includes one or more of a logical block address (LBA) associated with the command, a physical location of a memory block associated with the command, an age of the memory block associated with the command and a code rate associated with the memory block. In an example, the command attribute command parameter includes one or more of a command type, a command origin and a time parameter. In an example, the execution weight is determined based, at least in part, on a number of received commands exceeding a threshold.

Examples also describe a system, comprising: means for receiving a command associated with a data storage device; means for determining one or more command parameters associated with the command, the one or more command parameters being selected from a group of command parameters including, a data attribute parameter, a data location parameter and a command attribute parameter; means for determining an execution weight for the command based, at least in part, on the one or more command parameters; and means for determining an execution order for the command based, at least in part, on the execution weight of the one or more command parameters. In an example, the execution order is based, at least in part, on a determined force and wherein the determined force is proportional to the execution weight of the one or more command parameters. In an example, the system also includes means for comparing the execution weight of the command to an execution weight of one or more previously received commands. In an example, the system also includes means for determining whether the command is received from a host device or whether the command is a system command.

One of ordinary skill in the art will recognize that the technology described herein is not limited to a single specific memory structure, but covers many relevant memory structures within the spirit and scope of the technology as described herein and as understood by one of ordinary skill in the art.

The term computer-readable media as used herein may include computer storage media. Computer storage media may include volatile and nonvolatile, removable and non-removable media implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by a computing device (e.g., host device 105 (FIG. 1)). Any such computer storage media may be part of the computing device. Computer storage media does not include a carrier wave or other propagated or modulated data signal.

Additionally, examples described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various examples.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A method, comprising:
receiving a command for execution on a data storage device;
determining command parameters associated with the command, the command parameters being selected from a group of command parameters including a data attribute parameter, a data location parameter and a command attribute parameter;
determining an execution weight for one or more of the command parameters; and
determining an execution order for the command based, at least in part, on the execution weight of the one or more command parameters.

2. The method of claim 1, wherein the execution order is based, at least in part, on a determined force and wherein the determined force is proportional to the execution weight of the one or more command parameters.

3. The method of claim 1, wherein the command is a system command.

4. The method of claim 1, wherein the command is received from a host device.

5. The method of claim 1, wherein the execution order is based, at least in part, on a first time parameter and a second time parameter.

6. The method of claim 1, wherein the data attribute command parameter includes one or more of a size of data associated with the command and a temperature of the data associated with the command.

7. The method of claim 1, wherein the data location command parameter includes one or more of a logical block address (LBA) associated with the command, a physical location of a memory block associated with the command, an age of the memory block associated with the command and a code rate associated with the memory block.

8. The method of claim 1, wherein the command attribute command parameter includes one or more of a command type, a command origin and a time parameter.

9. The method of claim 1, wherein the execution weight is determined based, at least in part, on a number of received commands exceeding a threshold.

10. A system, comprising:
a controller; and
a memory storing instructions that, when executed by the controller, perform operations, comprising:
determining one or more command parameters associated with a received command, the one or more command parameters being selected from a group of command parameters including, a data attribute parameter, a data location parameter and a command attribute parameter;
determining an execution weight for each of the one or more command parameters; and
determining a force associated with the command, wherein the force is proportional to the execution weight of each of the one or more command parameters.

11. The system of claim 10, further comprising instructions for determining an execution order for the command based, at least in part, on the force.

12. The system of claim 11, further comprising instructions for comparing the force of the command to a force of one or more previously received commands.

13. The system of claim 10, wherein the data attribute command parameter includes one or more of a size of data associated with the command and a temperature of the data associated with the command.

14. The system of claim 10, wherein the data location command parameter includes one or more of a logical block address (LBA) associated with the command, a physical location of a memory block associated with the command, an age of the memory block associated with the command and a code rate associated with the memory block.

15. The system of claim 10, wherein the command attribute command parameter includes one or more of a command type, a command origin and a time parameter.

16. The system of claim 10, wherein the execution weight is determined based, at least in part, on a number of received commands exceeding a threshold.

17. A system, comprising:
means for receiving a command associated with a data storage device;
means for determining one or more command parameters associated with the command, the one or more command parameters being selected from a group of command parameters including, a data attribute parameter, a data location parameter and a command attribute parameter;
means for determining an execution weight for the command based, at least in part, on the one or more command parameters; and
means for determining an execution order for the command based, at least in part, on the execution weight of the one or more command parameters.

18. The system of claim 17, wherein the execution order is based, at least in part, on a determined force and wherein the determined force is proportional to the execution weight of the one or more command parameters.

19. The system of claim 18, further comprising means for comparing the execution weight of the command to an execution weight of one or more previously received commands.

20. The system of claim 17, further comprising means for determining whether the command is received from a host device or whether the command is a system command.
